(19) United States
(12) Patent Application Publication
(10) Pub. No.: US 2011/0090795 A1
(43) Pub. Date: Apr. 21, 2011

(54) DIFFERENTIATION AMONG OCCURRENCES OF PACKET REORDERING, CONGESTIVE PACKET LOSS, OR RANDOM PACKET LOSS IN COMMUNICATION NETWORKS

(76) Inventors: Victor On Kwok Li, Hong Kong (CN); Chengdi Lai, Hong Kong (CN); Ka-Cheong Leung, Hong Kong (CN)

(21) Appl. No.: 12/879,880

(22) Filed: Sep. 10, 2010

Related U.S. Application Data
(60) Provisional application No. 61/241,689, filed on Sep. 11, 2009.

(51) Int. Cl. H04L 12/26

(52) U.S. Cl. 370/235

(57) ABSTRACT

Example embodiments disclosed herein may relate to differentiating among network congestion, packet reordering, or random packet loss in wireless networks.

This application claims priority from U.S. Provisional Application Ser. No. 61/241,689, filed Sep. 11, 2009, and entitled “Differentiation Among Occurrences of Packet Reordering, Congestive Packet Loss, and Random Packet Loss In Communication Networks.”

### BACKGROUND

1. Field:

Subject matter disclosed herein may relate to end-to-end congestion control for wireless networks. More specifically, subject matter disclosed herein may relate to improved differentiation among occurrences of network congestion, packet reordering, or packet loss for wireless networks.

2. Information:

The Transmission Control Protocol (TCP) comprises a transport layer protocol for current networks, providing connection-oriented end-to-end in-order signal delivery services for various applications. Traditionally, design of TCP relies on assumptions of nearly in-order packet delivery or nearly error-free transmission. For example, a TCP receiver would expect sequence numbers of received packets belonging to a particular flow to be consecutively ordered. Otherwise, a TCP receiver may return a duplicate acknowledgment to a corresponding TCP sender for individual received packets failing expectation. At a sender side, if an amount of duplicate acknowledgments exceeds a specified threshold value, various congestion control measures may be activated. A congestion window (cwnd) size may be reduced. Therefore, out-of-order packet events are effectively treated as an indication of network overload.

However, while network congestion may result in out-of-order packet events over conventional wired networks, wireless networks may experience random packet loss or packet reordering as sources of such events.

As compared with wired media, a wireless medium may provide much more lossy physical links for signal transmission. Signals propagating over wireless channels may suffer from degradation, interference, or noise. Packets received may be damaged beyond recovery capabilities of error correcting codes, if any, in a receiver. Damaged packets may thus be discarded, leading to occurrences of random packet loss. In wireless networks, random packet loss is not uncommon.

### BRIEF DESCRIPTION OF THE FIGURES

Claimed subject matter is particularly pointed out and distinctly claimed in the concluding portion of the specification. However, both as to organization and/or method of operation, together with objects, features, or advantages thereof, claimed subject matter may be better understood by reference to the following detailed description if read with the accompanying drawings.

FIG. 1 is a flowchart depicting an example embodiment of a process for activating packet retransmission or congestion control measures.

FIG. 2a is a diagram illustrating an example embodiment of a process for activating packet retransmission or congestion control measures.

FIG. 2b is an illustration depicting an example embodiment of a process for activating packet retransmission or congestion control measures.

FIG. 2c is a diagram illustrating an example embodiment of a process for activating packet retransmission or congestion control measures.

FIG. 2d is an illustration showing an example embodiment of a process for activating packet retransmission or congestion control measures.

FIG. 3 is a flowchart illustrating an example update process for maintaining storage of round trip time samples for an embodiment.

FIG. 4a is a diagram illustrating an example round trip time update process.

FIG. 4b is an illustration depicting an example round trip time update process.

FIG. 4c is a diagram illustrating an example round trip time update process.

FIG. 5 is a flowchart illustrating an example process for activating congestion control measures in accordance with an embodiment.

FIG. 6a is a diagram illustrating an example network topology utilized in various simulation experiments.

FIG. 6b is a diagram illustrating an additional example network topology utilized in various simulation experiments.

FIG. 6c is a diagram illustrating an example network topology utilized in various simulation experiments.

FIG. 6d is a diagram illustrating an additional example network topology utilized in various simulation experiments.

FIG. 7 is a diagram plotting normalized throughput values for a number of example transmission control protocol (TCP) communication flows implemented in accordance with one or more embodiments against a number of communication flows.

FIG. 8 is a diagram plotting total throughput of all example TCP flows against a number of flows.

FIG. 9 is a diagram of an example throughput performance comparison of an example protocol implemented in accordance with one or more embodiments with a number of existing TCP variants over an infrastructure-based wireless network.

FIG. 10 is a diagram depicting an example throughput performance comparison of an example protocol implemented in accordance with one or more embodiments with a number of existing TCP variants over a multi-hop ad-hoc wireless network.

FIG. 11 is a diagram depicting an example throughput performance comparison of an example protocol implemented in accordance with one or more embodiments with a number of existing TCP variants over a wired network with a bottleneck-link of time-varying delay.

FIG. 12 is a diagram depicting an example throughput performance comparison of an example protocol implemented in accordance with one or more embodiments with a number of existing TCP variants over a mobile ad-hoc network.

FIG. 13 is a block diagram depicting an example embodiment of a computing platform.

Reference is made in the following detailed description to the accompanying drawings, which form a part hereof, wherein like numerals may designate like parts throughout to indicate corresponding or analogous elements. For simplicity or clarity of illustration, elements illustrated in the figures have not necessarily been drawn to scale. For example, dimensions of some elements may be exaggerated relative to other elements for clarity. Further, it is to be understood that other embodiments may be utilized and structural or logical changes may be made without departing from the scope of claimed subject matter. It should also be noted that directions and references such as, for example, up, down, top, bottom, over, above and so on, may be used to facilitate the discussion of the drawings and are not intended to restrict application of claimed subject matter. Therefore, the following detailed description is not to be taken in a limiting sense and the scope of claimed subject matter is intended to be defined by the appended claims and equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Packet reordering refers to disruption in a packet order of a communication flow established in accordance with a communication protocol, such as the Transmission Control Protocol (TCP). Despite conventional beliefs that packet reordering comprises a transient or pathological network behavior, it may be observed over modern networks and may be attributed at least in part to any of a myriad of reasons. Due at least in part to high transmission error rates and, in some cases, mobility in wireless networks, packet reordering may further increase in the event a transmission medium evolves from physical cables to a wireless medium. For example, packet reordering may be commonly observed over wireless networks, including link layer retransmission (LLRTX), path change, or hand-off, described below.

LLRTX: To address transmission error rates of wireless channels, some link layer retransmission mechanisms have been proposed to locally retransmit damaged packets at a link layer. As a side effect of local retransmission, packet order of a flow may be altered.

Path Change: Over mobile ad-hoc networks, a TCP flow, for example, may traverse through a number of wireless nodes. A transmission path of a flow may be altered if one or more nodes move. A round trip time (RTT) of a connection may also change. Consequently, it may be possible that some packets transmitted after a path change arrive at a receiving end before one or more packets transmitted prior to path change.

Hand-Off: In infrastructure-based networks, a transmission coverage of an area may be achieved cooperatively by a set of base stations. If a mobile client moves from a radio range of one base station to that of another, a hand-off between these two base stations takes place. A transmission path for a flow may therefore be changed. Using a token, such as in the case of a path change, a resulting variation in RTT may lead to one or more occurrences of packet reordering.

Therefore, in wireless networks, packet reordering or random packet loss, in addition to packet losses due at least in part to network congestion (referred to herein as congestive packet loss), may result in out-of-order events. Due at least in part to conventional designs not being compliant with TCP, congestion control measures may be spuriously activated, keeping the congestion window (cwnd) unnecessarily small, thereby resulting in under-utilization of available network resources.

Problems of packet reordering or random packet loss have resulted in efforts to modify TCP to adapt it to wireless networks. Currently, these modified TCP variants fall into three different categories of packet reordering, random packet loss, or packet reordering and packet loss.

Prior approaches to packet reordering focused at least in part on detecting spurious retransmission after activating packet retransmission or congestion response. These approaches infer a path change upon a successful detection. Yet, as shown by simulation results, persistent packet reordering may interfere with performance.

By contrast, other prior approaches to packet reordering defer packet retransmission or congestion response until an occurrence of packet loss may be accurately confirmed. However, these variants may rely on link layer retransmission (LLRTX) to provide an almost error-free transmission channel and further may assume absence of random packet loss. After detection of a packet loss, congestion response, in addition to packet retransmission, may also be activated. Simulation results reveal, however, that these prior approaches may suffer performance deterioration if LLRTX is unavailable.

At least some prior approaches to random packet loss may focus on differentiating between congestion loss and non-congestion loss while not attending to packet reordering. This limitation restricts the prior approaches' applicability to networks with nearly in-order packet delivery. Particularly, their interoperability with LLRTX may be undermined.

Other prior approaches to packet reordering or random packet loss involve high deployment cost. For example, at least one prior approach introduces a layer between TCP and the internet protocol (IP). The introduced layer switches TCP among various pre-defined states in accordance with network conditions to address spurious packet retransmission or congestion response.

One or more embodiments described herein relate to end-to-end congestion control over wireless networks. For example, one or more embodiments may improve communication protocol performance in wireless networks by differentiating among network congestion, packet reordering, or random packet loss.

Although embodiments described herein refer to TCP, the scope of the various example embodiments are not limited to any particular protocol. Further, references to TCP herein refer to transfer protocols implemented in a manner compatible with or compliant with TCP.

For an example embodiment, a new retransmission decision timer RD; may be started if a new packet Pᵢ is injected into the network. If the acknowledgment for Pᵢ, ACKᵢ, is received at the TCP sender before RDᵢ expires, RDᵢ may be cancelled. Otherwise, after expiration of RDᵢ, Pᵢ may be deemed as probably lost and retransmitted and a congestion response decision timer CDᵢ may be started. CDᵢ may be cancelled if ACKᵢ arrives before it expires. Otherwise, it would be further inferred that Pᵢ is probably lost due to network overload. Congestion control mechanisms may be activated in response to expiration of CDᵢ. Expiration periods of RDᵢ and CDᵢ may be specified to be the maximum and the minimum values over a range of recently recorded RTT samples, respectively, for an example embodiment.

For the present example embodiment, a TCP non-congestive loss (NCL) RTT update process (TCP-NCL-RTT-Update) may be activated if ACKᵢ arrives before CDᵢ expires. To address ambiguity regarding whether the ACKᵢ is for the originally transmitted Pᵢ or the retransmitted Pᵢ, the process may, in an embodiment, compute an RTT sample for Pᵢ if and only if ACKᵢ arrives no later than a prescribed time instance after RDᵢ expires.

Regarding activation of congestion control mechanisms, packet losses within a signal burst may be considered a single signal with respect to onset of network congestion and reduction of a congestion window may be triggered once. For one or more embodiments, evolution of a congestion window may follow slow start and congestion reduction processes as specified in RFC 2581. [Allman et al. “TCP Congestion Control,” Request for Comments, RFC 2581, Network Working Group, Internet Engineering Task Force, April 1999] However, other embodiments may employ other approaches.

Example embodiments described herein may be referred to as TCP for Non-Congestive Loss (TCP-NCL). Of course, as previously mentioned, TCP is merely an example communication protocol, and other embodiments may be implemented based at least in part on other communication protocols. Further, embodiments described herein may employ variations to TCP, in one or more embodiments. Example embodiment TCP-NCL, as described herein, comprises an extension of sender-side TCP for improving performance of TCP over wireless networks by enabling TCP to differentiate among occurrences of network congestion, packet reordering, or random loss.

The following variables are used in describing an example embodiment, referred to as TCP-NCL. Other symbols are of local use exclusively within a particular section and will be defined in those sections.
ACKᵢ represents an acknowledgment packet for Packet Pᵢ;
β comprises a system design parameter falling between zero and one;
CDᵢ represents a congestion response decision timer for packet Pᵢ;
cwnd represents size of a congestion window;
maxRTT represents a maximum round-trip time (RTT) sample in storage;
minRTT represents a minimum RTT sample in storage;
Pᵢ represents an i'th data packet transmitted by a TCP sender to a TCP receiver;
RDᵢ represents a retransmission decision timer for packet Pᵢ;
RTTᵢ comprises the RTT for packet Pᵢ;
ssthresh represents a slow start threshold value;
SMSS comprises a size of a largest packet that a sender can transmit;
t_{Pi} comprises a time instant at which a Packet Pᵢ is injected into a network;
t_{ACKi} comprises a time instant at which an ACKᵢ arrives at a TCP sender, or if multiple ACKᵢ's arrive, a time instant a first ACKᵢ arrives;
T_{RDi} represents an expiration period of RDᵢ;
T_{CDi} represents an expiration period of CDᵢ;

In conventional TCP variants for dealing with persistent packet reordering, such as RR-TCP, TCP-DCR, and TCP-PR, packet retransmission or congestion response mechanisms are generally bundled together. A limitation may be that information inferred by occurrence of the events which happen after packet retransmission may be overlooked, thereby increasing a possibility of spurious congestion control activation. For example, if an acknowledgment for a packet lags behind a retransmission of that packet by a short duration, congestion control measures generally bundled with packet retransmission may be unnecessary. An acknowledgment packet may be for an originally transmitted packet or a retransmitted packet. The former case rejects possibility of a congestive loss. In the latter case, a fairly short round-trip time and thus a lightly loaded network may be inferred. Based at least in part on the observation noted above, packet retransmission and congestion control may be separated for one or more example embodiments described herein, such as for the following illustrative example.

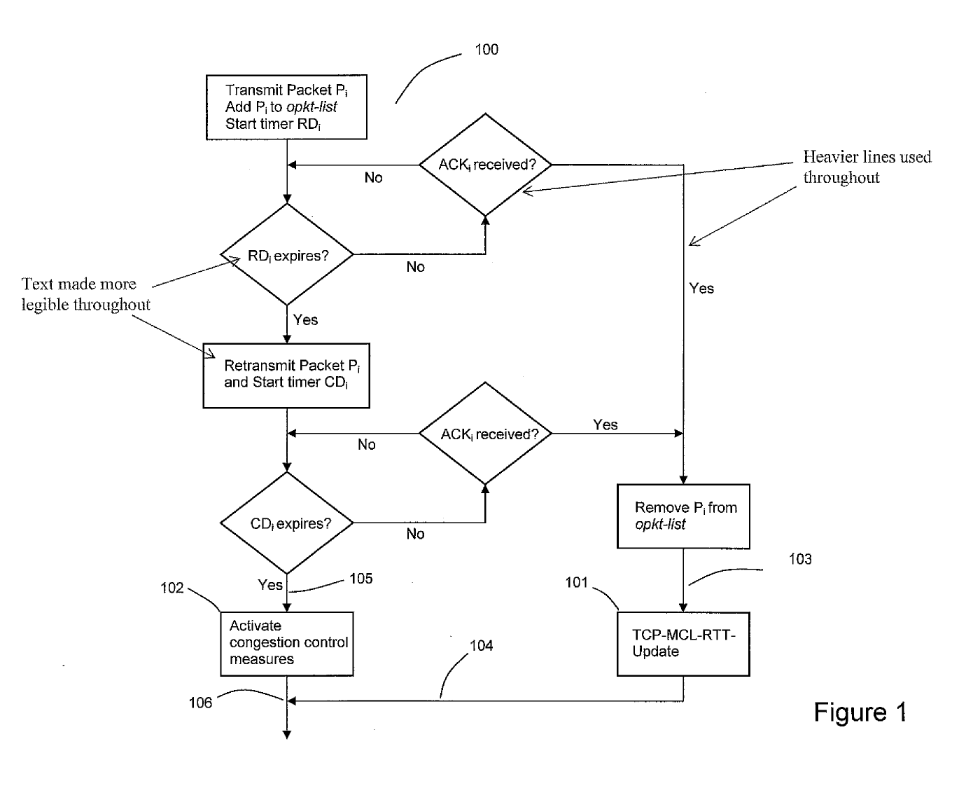

FIG. 1 shows a flowchart depicting an example process embodiment 100. RDᵢ may be started in response to Pᵢ being injected into a network. If ACKᵢ is received by packet Pᵢ sender before RDᵢ expires, RDᵢ may be cancelled. Otherwise, at least in part in response to expiration of RDᵢ, Pᵢ may be retransmitted and CDᵢ may be started. CDᵢ may be cancelled if ACKᵢ arrives before CDᵢ expires. Otherwise, process embodiment 102 of activating congestion control mechanisms may be entered after expiration of CDᵢ and the size of cwnd may be halved. Therefore, installation of CDᵢ may allow a TCP sender extra time after packet retransmission to decide whether to activate congestion control. ACKᵢ arriving before expiration of CDᵢ may be interpreted as an indication little or no network congestion, and that activation of congestion control measures may be necessary.

A set of memory locations for recording or storing outstanding packets, outstanding-packet-list (herein referred to as opkt-list), may be defined and initialized to empty at the beginning of a TCP session. Packet Pᵢ may be added to opkt-list in response to it being first transmitted and may be removed from the set if ACKᵢ arrives at or reaches a TCP sender. An opkt-list may be maintained for facilitating an operation of process embodiment 102, as will be discussed later.

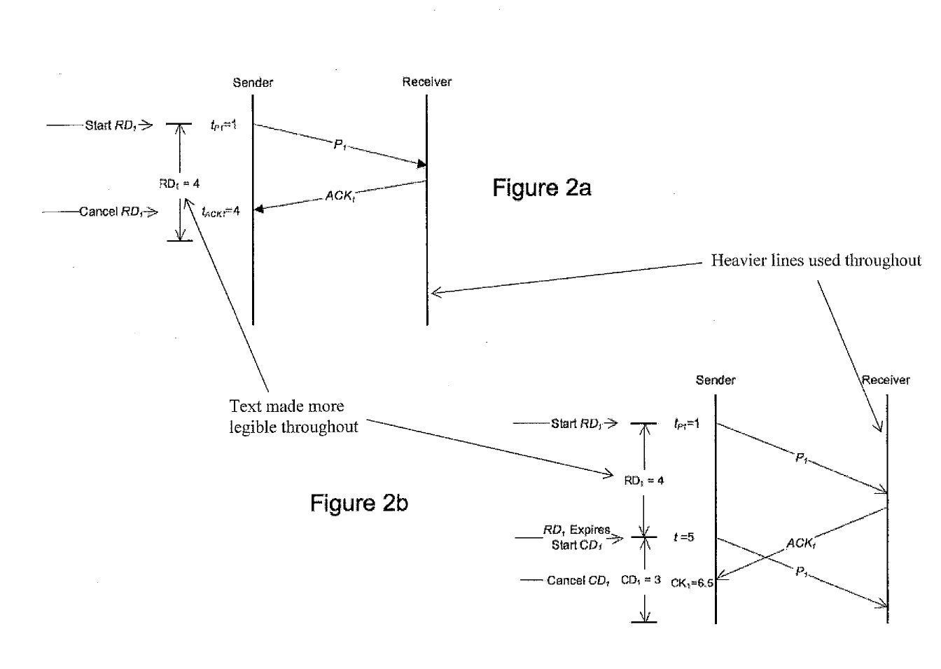

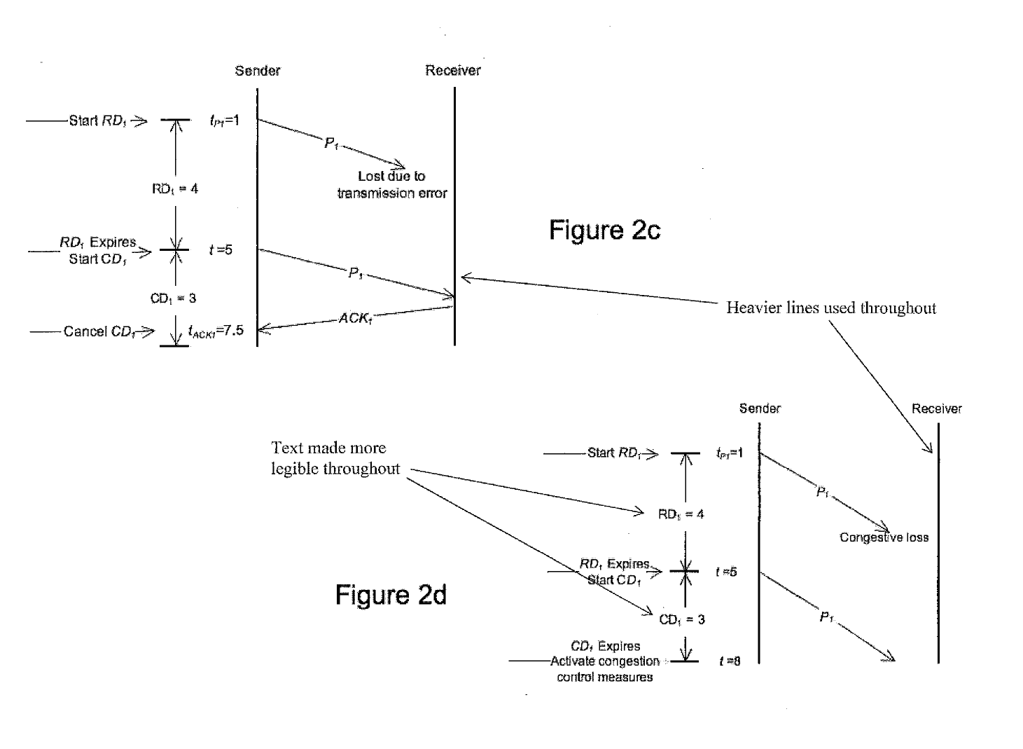

FIGS. 2a-2d illustrate how for at least one embodiment decisions may be made on whether to activate packet retransmission or congestion control measures. FIG. 2a shows a situation in which ACK₁ arrives at a TCP sender before RD₁ expires. Neither packet retransmission nor congestion control measures are activated in this case, for an example embodiment.

FIGS. 2b and 2c show a situation in which ACK₁ arrives after RD₁ expires but before CD₁ expires. P₁ may be retransmitted after expiration of RD₁ but congestion control measures are not necessarily activated. FIG. 2d for this example embodiment illustrates that ACK₁ does not arrive before CD₁ expires. P₁ may be retransmitted after expiration of RD₁. Congestion control measures may be activated after expiration of CD₁.

It may be observed that TCP-NCL may be able to make decisions under three distinct situations depicted by FIGS. 2a through 2d. In other words, retransmission of packets may be triggered in the event of lost packets or congestion control measures may be triggered in the event of congestive loss. In the case of FIG. 2b, TCP-NCL may activate packet retransmission unnecessarily. Nevertheless, activation of congestion control may be substantially addressed.

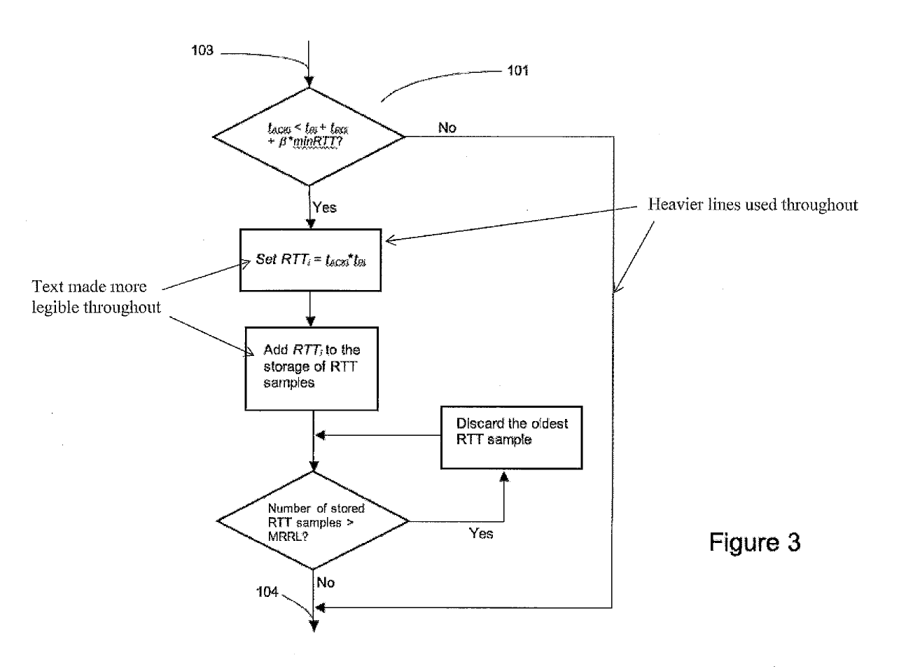

FIG. 3 depicts a TCP-NCL-RTT-Update process embodiment 101 for maintaining storage of RTT samples, for example. Process 101 samples RTT of Packet Pᵢ if ACKᵢ arrives before expiration of RDᵢ or between expiration of RDᵢ and CDᵢ. In the latter case, there is an ambiguity regarding whether the ACKᵢ corresponds to an originally transmitted packet or a retransmitted packet. Thus, measures may be employed so that ACKᵢ may be checked before recording a corresponding RTT sample. Time elapsed, for example, between retransmission of Pᵢ and arrival of ACKᵢ may be measured for an example embodiment. If the measured value is less than β*minRTT, it may be inferred that the RTT sample be recorded accordingly. Otherwise, the corresponding RTT sample may be ignored. In other words, for an embodiment, RTT may be sampled for Pᵢ as:

RTTᵢ=t_{ACKi}−t_{Pi} (2.1)

where:

t_{ACKi}<t_{Pi}+T_{RDi}+β*minRTT (2.2)

By updating RTT based at least in part on acknowledgments received between expirations of RDᵢ and CDᵢ, robustness of RTT sampling process 101 to changes in a network environment may be increases, especially to occurrence of an abrupt increase in RTT, which may be incurred by path change or handoff. If there is an abrupt increase in RTT, ACKᵢ may not be received before RDᵢ expires. Yet, the corresponding RTT sample may still be accurately recorded if it does not exceed T_{RDi}+β*minRTT, for an example embodiment.

Distribution of RTT may be time-variant over most wireless networks, which in turn may result in periodic updating of RTT samples so that recent RTT samples are recorded and some outdated samples are discarded. Thus, a maximum RTT record length (herein referred to as MRRL) may be defined. In the event the total number of stored RTT samples exceeds MRRL, the oldest samples (meaning samples recorded at the earliest times) may be discarded, for one or more embodiments.

For an example embodiment, robust values for β and MRRL should be employed. β should be sufficiently small so that acknowledgments for retransmitted packets do not significantly affect RTT sampling. Yet, a too conservative β may undermine a robustness of TCP-NCL-RTT-Update for an abrupt increase in RTT. MRRL should be large enough to allow storage of a sufficiently large RTT sample, but should also be appropriately limited so that outdated samples may be discarded in time, for an embodiment. Nevertheless, simulation results reveal that performance may be robust over a wide range of combinations of values for β and MRRL (0.5≦β≦0.95, 200≦β≦1000). For an example embodiment, recommended values for β and MRRL may comprise:

β=0.8 (2.3)

MRRL=1000 (2.4)

although this is merely an illustrative example and is not intended to limit claim scope.

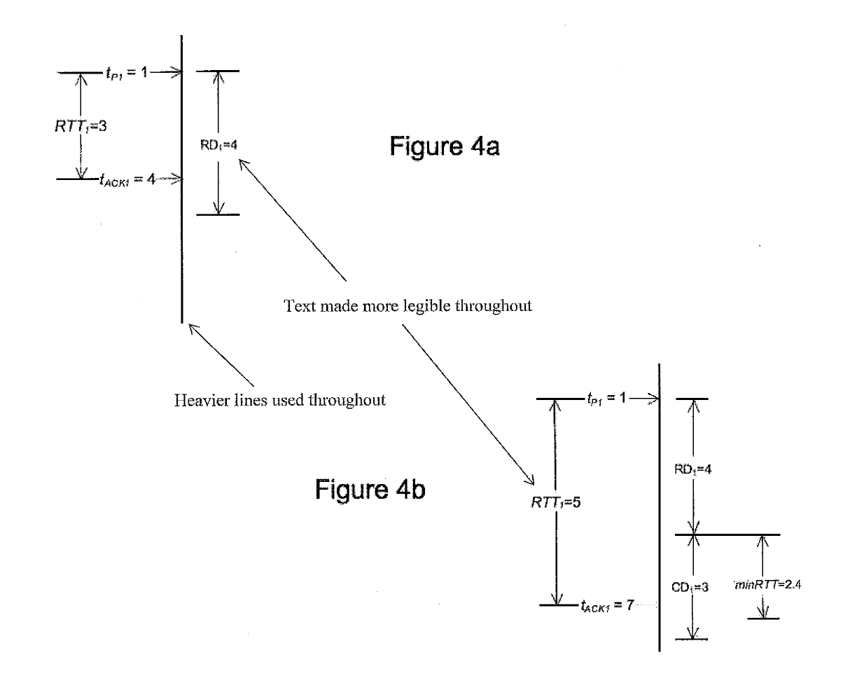

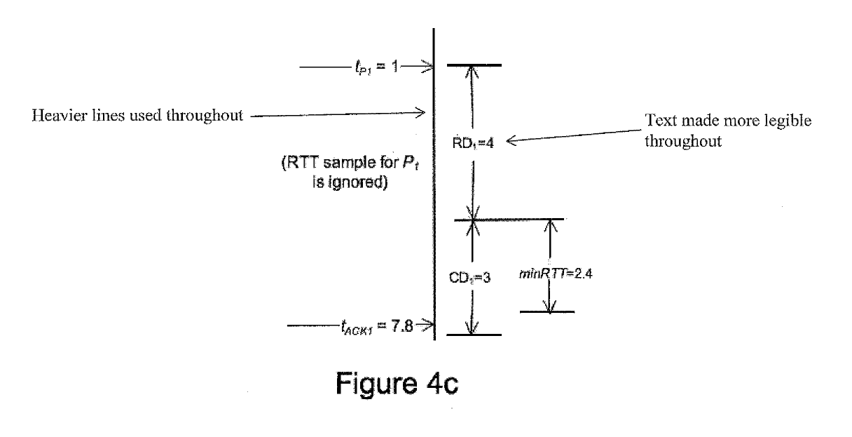

FIGS. 4a through 4c illustrate RTT sampling for an embodiment, given, as an example, β=0.8 and minRTT=3. FIG. 4a shows that ACKᵢ may arrive at a TCP sender before RDᵢ expires. Relation (2.2) may be satisfied and corresponding RTT may be sampled according to relation (2.1).

FIG. 4b illustrates a situation in which ACKᵢ may arrive after RDᵢ expires but before CDᵢ expires. Relation (2.2) may be satisfied in this case and a corresponding RTT may be sampled according to relation (2.1). FIG. 4c also shows a situation in which ACKᵢ may arrive after RDᵢ expires but before CDᵢ expires. Yet, relation (2.2) may be violated in this case and thus the corresponding RTT sample may be ignored, in this example.

Based at least in part on RTT samples maintained by a TCP-NCL-RTT-Update process, T_{RDi} may be set as:

T_{RDi}=maxRTT (2.5)

although this is merely an illustrative example and is not intended to limit claim scope.

An assignment of T_{RDi}; that reflects Packet Pᵢ may be lost with high probability after expiration of RDᵢ. Thus, spurious packet retransmission may be reduced. However, excessively delaying packet retransmission should generally not be an issue as well.

For an example embodiment, CD timers operate so that an ACK₁ arriving before expiration of CDᵢ should reject occurrence of congestive loss to Pᵢ. T_{CDi} should be no greater than a certain upper bound value, which is denoted as Tᵤ. Tᵤ is lower bounded by a minimum attainable RTT for Pᵢ. Therefore, an improved solution for T_{CDi} within [0, Tᵤ] may be determined. Consider a time period t (0≦t≦Tᵤ) after retransmission of packet Pᵢ, if a TCP sender may or may not activate a congestion response. Risk associated with a positive decision may be that the network may not be congested (e.g., the originally transmitted Pᵢ may not be dropped). Consequently, a spuriously activated congestion response may reduce a congestion window unnecessarily. However, if the network is indeed overloaded (e.g., the originally transmitted Pᵢ may be lost) and activation of congestion response is excessively delayed, network congestion may be exacerbated and an expensive retransmission timeout (RTO) may be incurred.

To quantify risk associated with activating a congestion response, a metric may be introduced, in an embodiment. An expected cost of activating a congestion response, EC_{A}(t), may be defined as:

EC_{A}(t)=P( C̅L̅ᵢ̅^̅{̅o̅}̅|PUᵢ(t))·C_{S} (2.6)

where C̅L̅ᵢ̅^̅{̅o̅}̅ denotes the event of originally transmitted Pᵢ not being lost, PUᵢ(t) denotes the event Pᵢ is unacknowledged by time t after retransmission of Pᵢ, P( C̅L̅ᵢ̅^̅{̅o̅}̅|PUᵢ(t)) denotes the conditional probability of C̅L̅ᵢ̅^̅{̅o̅}̅, given PUᵢ(t), and C_{S} denotes the throughput reduction attributable to activation of a congestion response.

Similarly, expected cost of delaying a congestion response, EC_{D}(t), may be introduced to quantify risk associated with delaying congestion response. It may be defined for an embodiment as:

EC_{D}(t)=P(CLᵢ^{o}∩RTO|PUᵢ(t))·C_{T} (2.7)

where CLᵢ^{o} denotes the event of originally transmitted Pᵢ not being lost, P(CLᵢ^{o}∩RTO|PUᵢ(t)) denotes the conditional probability of CLᵢ^{o} and RTO occurring, given PUᵢ(t), and C_{T} denotes throughput reduction.

For 0≦t≦Tᵤ, EC_{A}(t) and EC_{D}(t) may be derived as:

$$\begin{matrix}{EC}_{A} ( t ) = \frac{{p}_{w} [ 1 - ( 1 - {p}_{l} ) F ( t ) ]}{{p}_{c} + {p}_{w} [ 1 - ( 1 - {p}_{l} ) F ( t ) ]} {C}_{S} & ( 2.8 ) \\ {EC}_{D} ( t ) = \frac{{p}_{w} {p}_{l}}{{p}_{c} + {p}_{w} [ 1 - ( 1 - {p}_{l} ) F ( t ) ]} {C}_{T} & ( 2.9 )\end{matrix}$$

where p_{c} denotes the congestive loss rate, p_{w} denotes non-congestive loss rate, and pₗ denotes total loss rate.

C_{S} and C_{T} may be computed as:

C_{S}=0.5(W−┌0.5W┐)(W−┌0.5W┐+1) (2.10)

C_{T}=0.5(┌log₂0.5W┐W−2^{┌log}^{₂}^{0.5W ┐}+1) (2.11)

EC_{A}(t) monotonically decreases and EC_{D}(t) monotonically increases with t. Thus, if the activation of congestion response is postponed further, EC_{D}(t), which quantifies risk associated with delaying a congestion response, increases, while EC_{A}(t), which quantifies risk associated with activating a congestion response, drops. If EC_{A}(t) is greater than EC_{D}(t), it is advantageous to set T_{CDi} no less than t since the operational cost of triggering a congestion response comprises EC_{A}(t), which is larger than that of deferring it, EC_{D}(t). Cost may drop as t further increases. Similarly, if EC_{D}(t) is greater than EC_{A}(t), it is advantageous to set T_{CDi} no greater than t since the operational cost of deferring a congestion response comprises EC_{D}(t), which is larger than that of triggering it, EC_{A}(t). Cost may drop as t decreases. Therefore, for an embodiment, a solution for T_{CDi}, T_{CDi}*, corresponds to EC_{A}(T_{CDi}) just outweighing EC_{D}(T_{CDi}) subject to the constraint 0≦t≦Tᵤ, for an example embodiment.

Evaluation of T_{CDi}* may be divided into three cases. A first arises if EC_{D}(t) exceeds EC_{A}(t) for any t≧0. A gap between the two would continue to increase as t increases. Thus, a congestion response may be activated at t=0, or set T_{CDi}* to be zero. A second case arises if EC_{D}(t) fails to catch up with EC_{A}(t) for all t such that 0≦t≦Tᵤ. Assuming that we may not delay a congestion response further than Tᵤ according to a prior constraint, we may set T_{CDi}* to be Tᵤ. A final case arises if EC_{D}(t) catches up with EC_{A}(t) for some t such that 0≦t=T_{TH}≦Tᵤ As stated above, T_{CDi}* corresponds to T_{TH}.

Thus, for an example embodiment, T_{CDi}* may be given by:

$${τ}_{{CD}_{i}}^{*} - \{ \begin{matrix}0 , & {p}_{c} > \frac{{p}_{l} {C}_{S}}{{p}_{l} {C}_{T} + {C}_{S}} \\ {τ}_{u} , & {p}_{c} < \frac{{p}_{l} {C}_{S}}{\frac{{p}_{l}}{1 - ( 1 - {p}_{l} ) F ( {τ}_{u} )} {C}_{T} + {C}_{S}} \\ {τ}_{TH} , & otherwise\end{matrix} \\ where \\ {τ}_{TH} = {F}^{- 1} ( \frac{1 - \frac{{C}_{T} {p}_{c}}{{C}_{S} {p}_{w}}}{1 - {p}_{l}} ) . \qquad ( 2.12 )$$

It may be shown that

$${p}_{c} ≦ \frac{{p}_{l} {C}_{S}}{{p}_{l} {C}_{T} + {C}_{S}}$$

when p_{c}≦p_{c}<<1. Thus, it is reasonable to assume T_{CDi}* be T_{TH} or Tᵤ, depending at least in part on the value of p_{c}. A conservative estimation for both T_{TH} and Tᵤ may be set as a minimum attainable RTT for Pᵢ, in an embodiment. Hence, as an approximation, we may set

T_{CDi}=minRTT (2.13)

For activation of congestion control measures process embodiment 102, we may adopt an approach similar to the one used in TCP-PR that packet losses within the same burst may be considered as a single signal about onset of network congestion and reduction of cwnd may be triggered once, therefore.

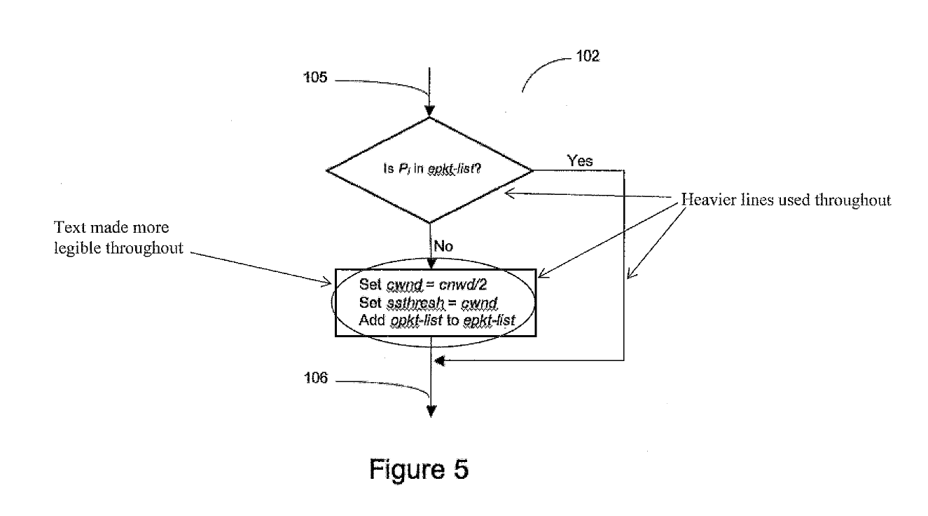

FIG. 5 shows process embodiment 102 of activating congestion control measures. A set of memory locations for recording packets, exempted-packet-list (epkt-list), may be defined and initialized to empty at the beginning of a TCP session. At least in part in response to entering process embodiment 102 of activating congestion control measures, if an outstanding packet Pᵢ is not in the epkt-list, cwnd and ssthresh may be set to half of the present cwnd, and the whole current opkt-list may be added to epkt-list. Otherwise, cwnd and ssthresh may be left intact since a probable congestive loss of Pᵢ may have already been responded to by an earlier reduction of cwnd for loss of previous packets within the same burst.

Evolution of cwnd for this example embodiment follows slow start or congestion avoidance as specified in RFC 2581, mentioned above, which may briefly be reiterated as follows.

An initial value of cwnd, IW, may satisfy:

IW≦2*SMSS (3.1)

An initial value of ssthresh may be arbitrarily high. A slow start process may be used if

cwnd≦ssthresh (3.2)

while a congestion avoidance process may be used if

cwnd>ssthresh. (3.3)

During slow start, cwnd may be incremented by SMSS bytes for an acknowledgment packet received that acknowledges additional signals. Slow start may end if cwnd exceeds ssthresh or if congestion is detected.

During a congestion avoidance process, cwnd may be incremented by SMSS bytes per RTT. As an example, a process may continue until congestion is detected, for an embodiment.

In an embodiment, a retransmission timeout (RTO) may be implemented in a manner compatible with a transmission control protocol (J. Postel. “Transmission Control Protocol”, RFC 793). RTO may be modified in an TCP-NCL embodiment so that it may occur in a controllable manner. An expiration period of a RTO timer, T_{RTO}, may be set to:

T_{RTO}=backoff*(T_{RDi}+2*T_{CDi};);

An RTO timer may reset after packet transmissions and retransmissions, in an embodiment. backoff may be set to “one” initially and may be reset to “one” after an acknowledgement of additional signal packets. After an occurrence of RTO, a size of a congestion window may be reduced to “one” and backoff may be doubled if it is no greater than 64. A determination may be made as to whether there are retransmitted packets that are not acknowledged within an expiration period of an RD timer, or whether a congestion window is no greater than one. If either is true, all or approximately all outstanding packets may be retransmitted at a rate regulated by a congestion window.

Below, performance of an embodiment example for TCP-NCL is compared with those of conventional TCP variants via simulation using Network Simulator (ns) Version 2.29 [Fall et al. “The ns manual (formerly ns Notes and Documentation)”, The VINT Project, January 2009.].

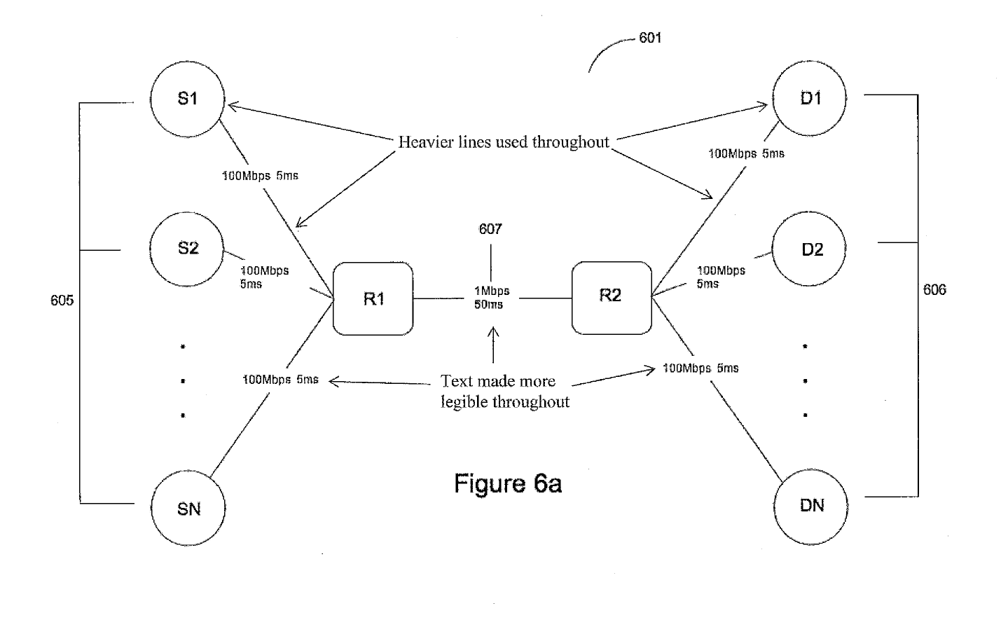

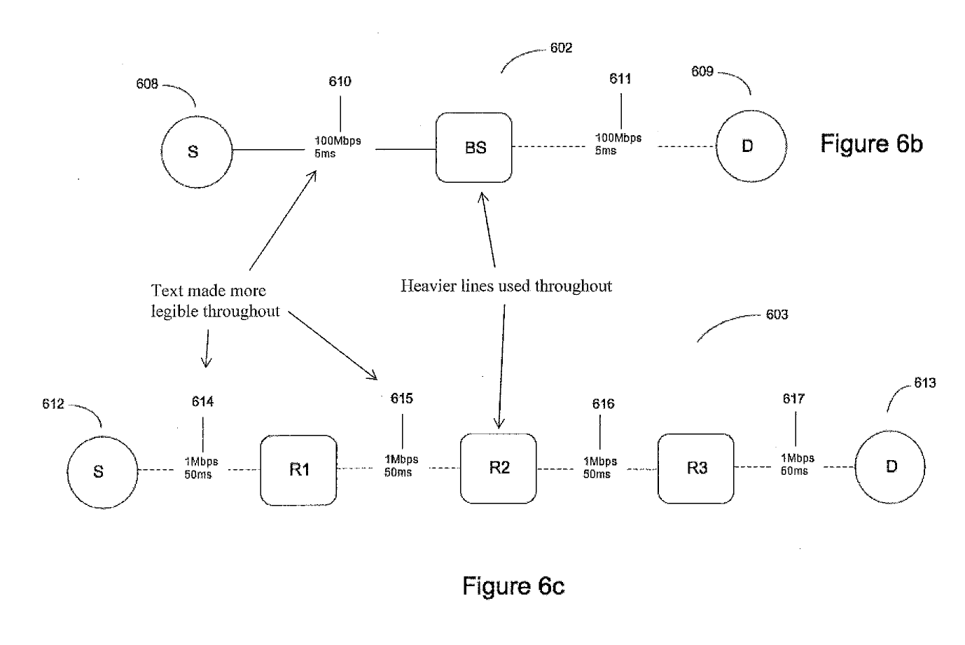

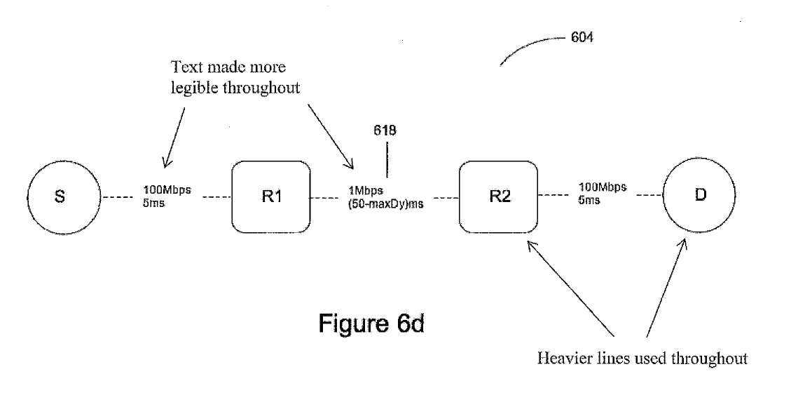

FIGS. 6a through 6d illustrate four different network topologies used in a simulation experiment: an example wired network with a dumbbell topology 601, an example infrastructure-based wireless network 602, an example multi-hop wireless network 603, and an example wired network with a bottleneck link of time-varying propagation delay 604. Performance of TCP-variants under congestive loss, random packet loss, persistent reordering, and occurrences of abrupt increase in RTT are to be examined.

FIG. 6a illustrates example wired network with a dumbbell topology 601. Multiple pairs of TCP-NCL senders 605 and receivers 606 share an error-free ordered bottleneck link 607. Thus, occurrences of packet loss here are due to network congestion. The number of sender-receiver pairs ranges here from one to ten.

FIG. 6b illustrates example infrastructure-based wireless network 602. A TCP sender 608 and a TCP receiver 609 are connected through a wired link 610 and a wireless link 611. Random channel error from zero to 15% is deliberately introduced into wireless link 611. A link-layer retransmission mechanism is disabled to simulate an in-order error-prone channel for a TCP flow.

FIG. 6c illustrates example multi-hop wireless network 603. A TCP sender 612 is connected to a TCP receiver 613 via four wireless links 614, 615, 616, 617. Random channel error is introduced into wireless links 614, 615, 616, 617 with an error rate ranging from zero to 15%. Link-layer retransmission is enabled to introduce persistent packet reordering. Under high channel error rate, however, local link-layer retransmission cannot guarantee successful packet delivery due to a retransmission limit (set to three). Consequently, TCP may be confronted with both packet reordering and random packet loss.

FIG. 6d illustrates the wired network with a bottleneck link of time-varying propagation delay 604. A TCP connection traverses through a bottleneck link 618. A link delay of a bottleneck link takes on a random value from an interval [50, maxDy] ms and is changed at 20 second intervals. maxDy ranges from 100 ms to 700 ms. This way, an RTT may experience abrupt variations (and thus abrupt increases in some cases)

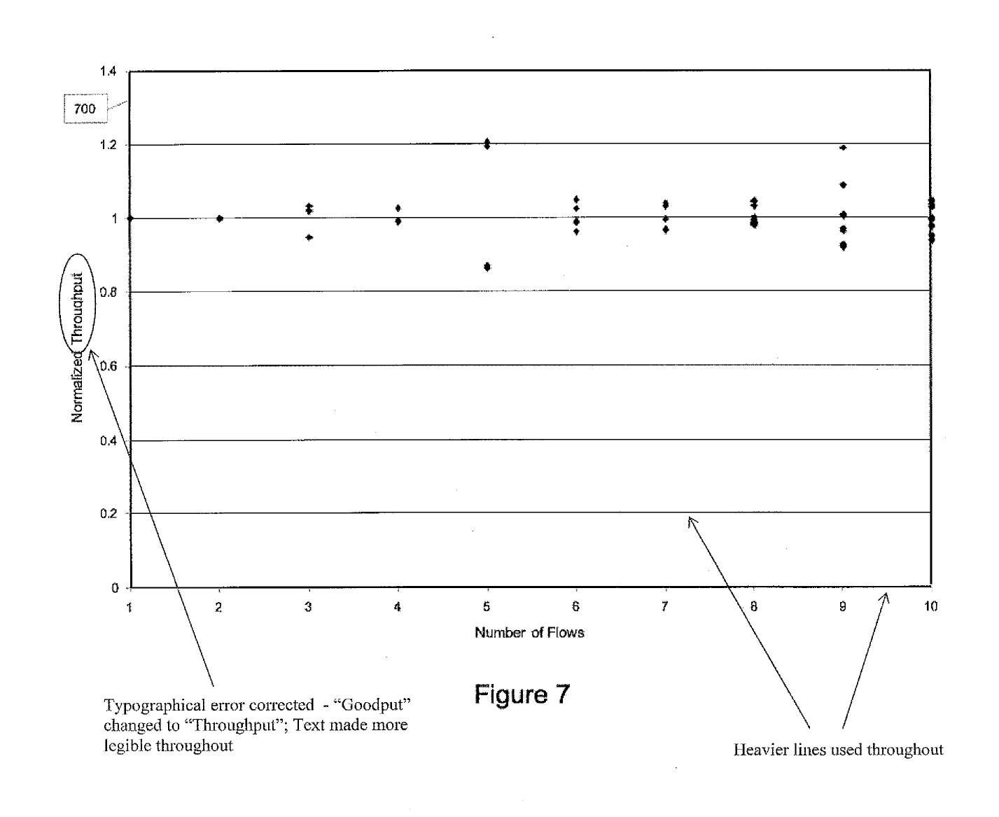

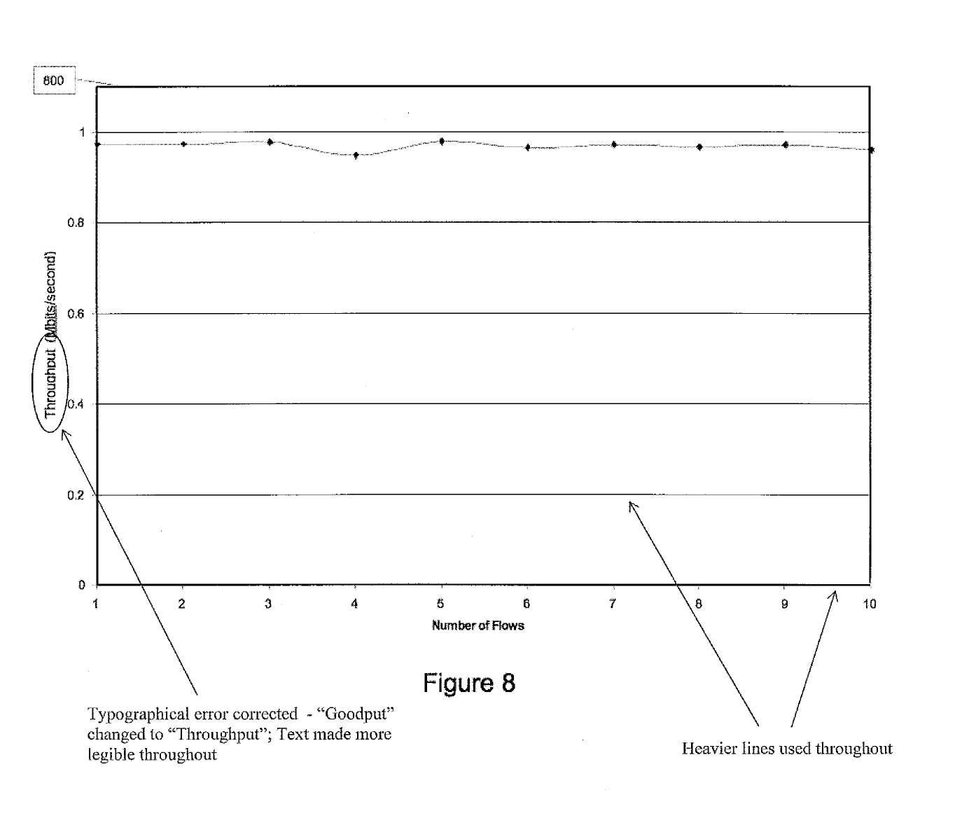

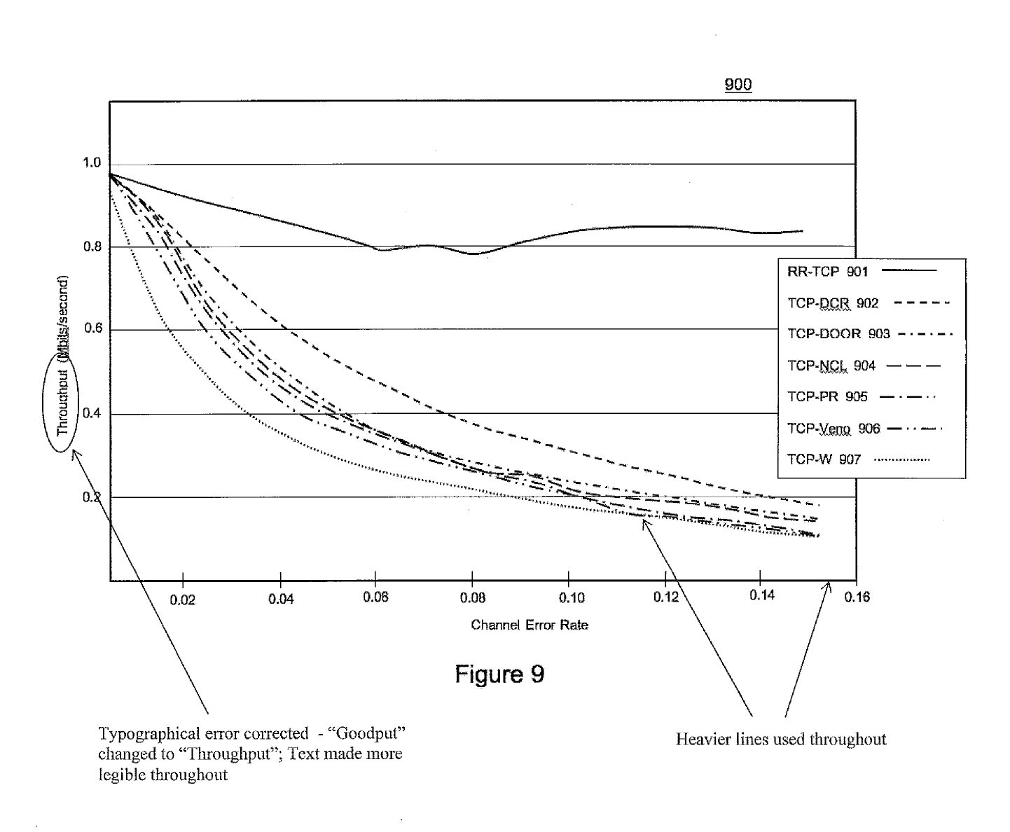

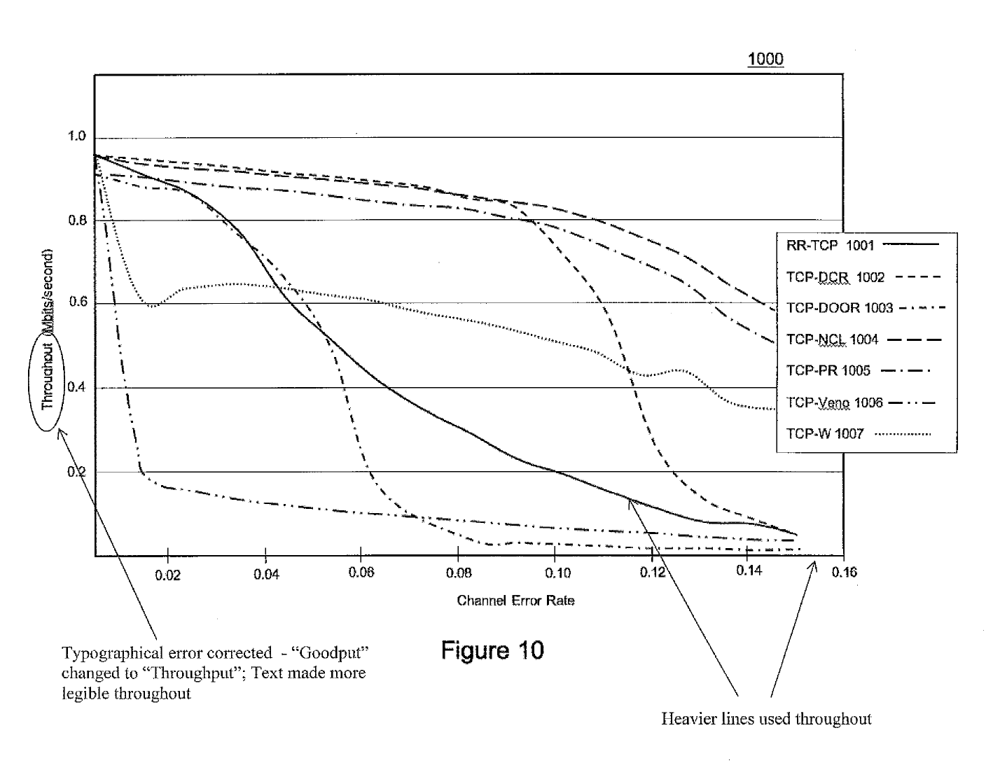

Simulation results are shown in FIG. 7, FIG. 8, FIG. 9, and FIG. 10. In the dumbbell topology 601, there are a number of TCP-NCL flows sharing bottleneck link 606. A normalized throughput of TCP flow, which is defined as a ratio of throughput to average throughput among the flows, is computed. FIG. 7 shows normalized throughputs plotted against number of TCP flows 700. Plotted normalized throughputs 700 are approximately one unit. FIG. 8 shows total throughput of TCP flows plotted against number of TCP flows 800, which may be observed to maintain at a high level despite an increase in number of flows. Thus, TCP-NCL flows are able to share bandwidth of a bottleneck link fairly and efficiently, demonstrating competent responsiveness in the presence of congestive loss only.

FIG. 9 shows connection throughput performance curves 900 of TCP variants over the infrastructure-based wireless network. In each test, a total of 20 runs have been performed to compute an average value and a 95% confidence interval of a connection throughput in megabit per second (Mbps). For TCP-NCL, MRRL is set to 1000 and β is set to 0.8. TCP-NCL 904 essentially maintains a stable throughput level against channel error rate from zero to 15%, whereas other TCP variants experience throughput decrease as error rate increases. An exception is TCP-W 907, which exhibits a relatively elegant performance deterioration. Performance of TCP-NCL 904 may be attributable to its effectiveness in differentiating between congestion loss and random packet loss, a merit introduced by postponing activation of congestion response until a congestion response decision timer expires. In contrast, RR-TCP 901, TCP-DCR 902, TCP-DOOR 903, and TCP-PR 905 exclude the possibility of random packet loss, resulting in under-utilization of network resources.

FIG. 10 shows connection throughput performance curves 1000 of TCP variants over multi-hop wireless network 603. In a test, a total of 20 runs have been performed to compute an average value and a 95% confidence interval of a connection throughput in megabit per second (Mbps). TCP-DCR 1002, TCP-NCL 1004, and TCP-PR 1005 outperform other variants for channel error rate less than 9%, thereby demonstrating robustness to persistent reordering. If the error rate further increases and random packet loss coexists with packet reordering, TCP-NCL 1004 performs slightly better than TCP-PR 1005 while performance of TCP-DCR 1002 is deteriorated. Again, in the latter scenario, installation of a congestion response decision timer plays a role in achieving performance improvement for TCP-NCL 1004.

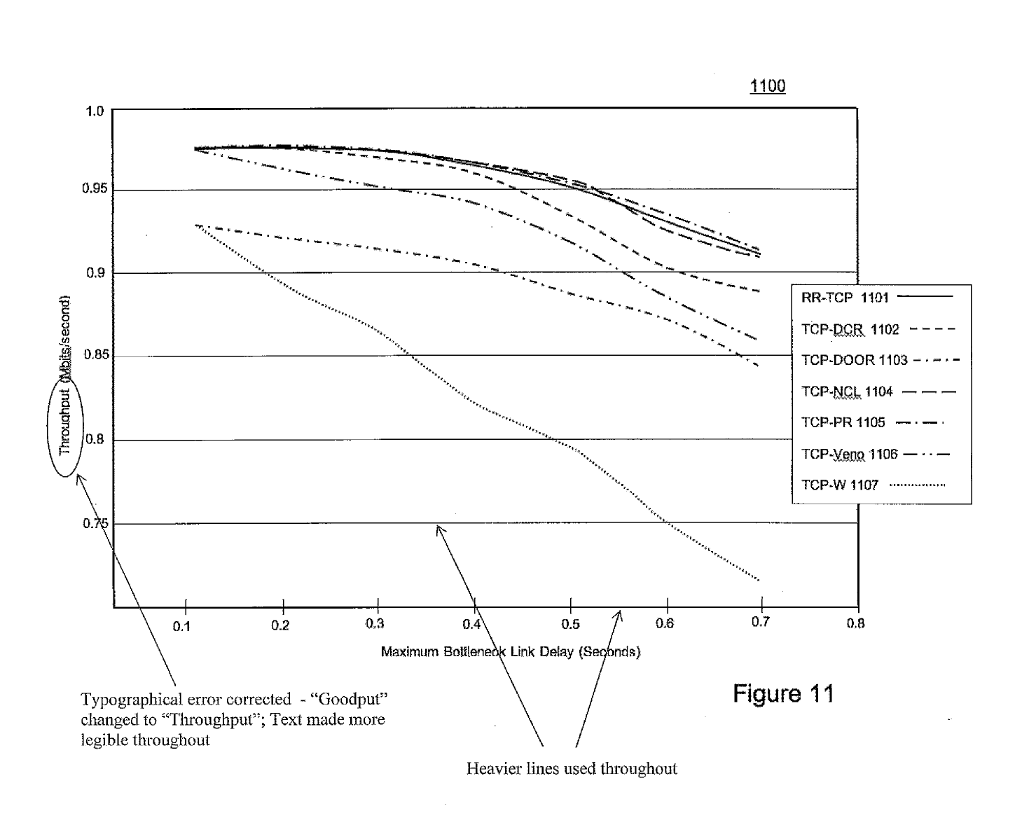

FIG. 11 shows connection throughput performance curves 1100 of TCP variants over the wired network topology 604 simulating occurrences of abrupt increases in RTT. In a test, a total of 20 runs have been performed to compute an average value and a 95% confidence interval of connection throughput in megabit per second (Mbps). Among possible solutions for packet reordering (RR-TCP 1101, TCP-DCR 1102, TCP-DOOR 1103, TCP-NCL 1104, TCP-PR 1105), TCP-DCR 1102 produces second worst performance gain attributable to its inability of maintaining accurate RTT sampling with the presence of abrupt RTT variations. If RTT abruptly increases, TCP-DCR tends to prematurely fire its fast retransmission timer and spuriously trigger packet retransmission. The RTT sample for the spuriously retransmitted packet and thus the increase in RTT is subsequently ignored, leading to further spurious packet retransmission. By contrast, RR-TCP 1101, TCP-NCL 1104, and TCP-PR 1105 offer improved connection throughput. Thus, a TCP-NCL-RTT-Update process 101 may be partially verified as a robust RTT sampling mechanism for occurrences of abrupt increases in RTT.

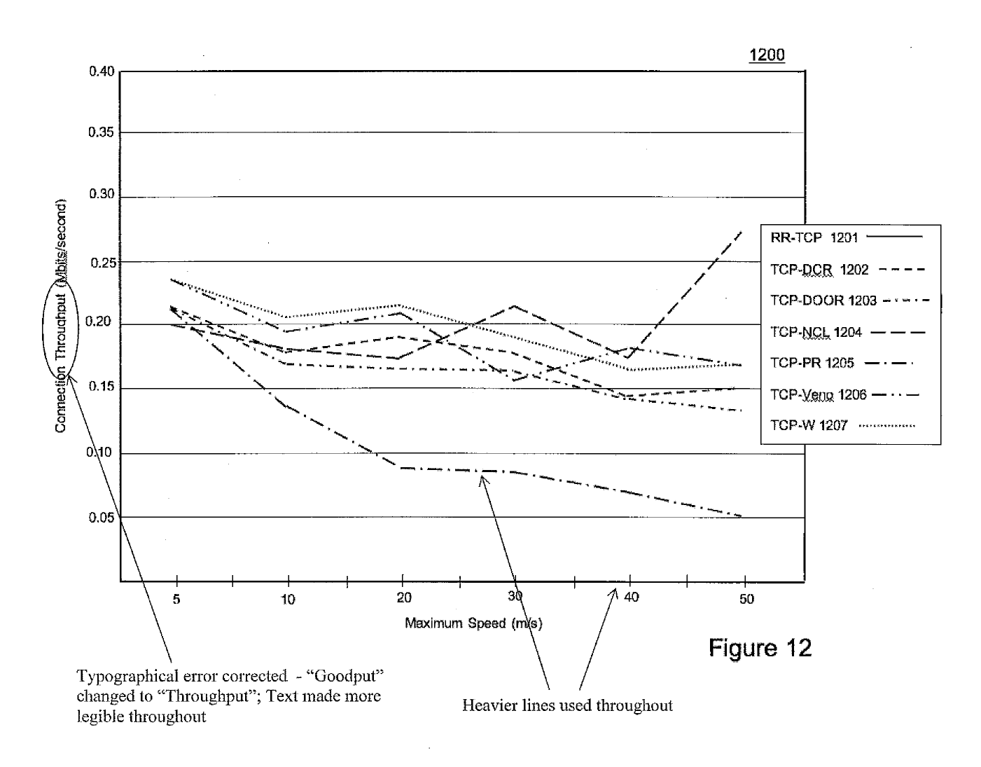

FIG. 12 shows connection throughput performance curves 1200 of TCP variants over a mobile ad-hoc network. A total of 16 mobile nodes are confined to an area of 1000 m×1000 m with initial positions uniformly distributed. Signal rate of a wireless interface is 2 Mbps. IEEE 802.11 serves as the MAC layer protocol with a transmission range of 250 m and a sensing range of 550 m. A TCP flow is set up between two selected nodes with DSR as an underlying routing process. The movement pattern follows the random waypoint model with a maximum speed set to maxSpeed and a maximum pausing time set to ten seconds. maxSpeed ranges from 5 m/s to 50 m/s. Thus, packet reordering may be incurred if path change leads to variations in RTT, while burst loss from temporary disconnection may result from node movement. A total of 80 runs, each lasting 2000 seconds and using different seeds for generating node movements, have been done for a test to compute an average value and a 95% confidence interval of TCP throughput in Mbps. To remove an effect of the transient states, statistics in the last 1000 seconds of run are collected for computing throughput. The TCP variants offer deteriorated throughput performance (below 15% of the interface rate), which may be attributable to occurrences of non-congestive burst loss from disconnections. In theory, it is possible for TCP-NCL to differentiate non-congestive burst loss from congestive loss, given that a corresponding disconnection event produces loss of originally transmitted packets within a window and may be recovered prior to the retransmission of these packets. During that event, retransmitted packets may be acknowledged in time so that a congestion response may not be falsely activated. This may explain why TCP-NCL 1204 generally appears to offer better performance than other variants under study (1201, 1202, 1203, 1205, 1206, and 1207).

FIG. 13 is a schematic diagram illustrating an example computing or communications environment 1300 that may include one or more devices capable of implementing techniques or processes described above, for example, in connection with example techniques discussed above or depicted in FIGS. 1-12. System 1300 may include, for example, a first device 1302, a second device 1304, and a third device 1306, which may be operatively coupled together through a wireless communication network 1308.

First device 1302, second device 1304 and third device 1306, as shown in FIG. 13, may be representative of any device, appliance or machine that may be capable of exchanging signals over wireless communications network 1308. By way of example but not limitation, any of first device 1302, second device 1304, or third device 1306 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or storage service provider/system, a network service provider/system, an Internet or intranet service provider/system, a portal or search engine service provider/system, a wireless communication service provider/system; or any combination thereof. Any of the first, second, and third devices 1302, 1304, or 1306, respectively, may comprise one or more of an almanac server, an access point, or a mobile station in accordance with examples described herein.

Similarly, network 1308, as shown in FIG. 13, is representative of one or more communication links, processes, or resources capable of supporting exchange of signals between at least two of first device 1302, second device 1304, and third device 1306. By way of example but not limitation, network 1308 may include wireless or wired communication links, telephone or telecommunications systems, signal buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 1306, there may be additional like devices operatively coupled to network 1308.

It is recognized that all or part of the various devices and networks shown in system 1300, and the processes and methods as further described herein, may be implemented using or otherwise including hardware, firmware, software, or any combination thereof.

Thus, by way of example but not limitation, second device 1304 may include at least one processing unit 1320 that is operatively coupled to a memory 1322 through a bus 1328.

Processing unit 1320 is representative of one or more circuits capable of performing at least a portion of a signal processing procedure or process. By way of example but not limitation, processing unit 1320 may include one or more processors, controllers, microprocessors, microcontrollers, application specific integrated circuits, digital signal processors, programmable logic devices, field programmable gate arrays, and the like, or any combination thereof.

Memory 1322 is representative of any signal storage mechanism. Memory 1322 may include, for example, a primary memory 1324 or a secondary memory 1326. Primary memory 1324 may include, for example, a random access memory, read only memory, etc. While illustrated in this example as being separate from processing unit 1320, it should be understood that all or part of primary memory 1324 may be provided within or otherwise co-located/coupled with processing unit 1320.

Secondary memory 1326 may include, for example, the same or similar type of memory as primary memory or one or more signal storage devices or systems, such as, for example, a disk drive, an optical disc drive, a tape drive, a solid state memory drive, etc. In certain implementations, secondary memory 1326 may be operatively receptive of, or otherwise capable of coupling to, a computer-readable medium 1340. Computer-readable medium 1340 may include, for example, any medium that is able to carry or make accessible signal information, code or instructions for one or more of the devices in system 1300. Computer readable medium 1340 may also be referred to as a storage medium.

Second device 1304 may include, for example, a communication interface 1330 that may provide for or otherwise support operative coupling of second device 1304 to at least network 1308. By way of example but not limitation, communication interface 1330 may include a network interface device or card, a modem, a router, a switch, a transceiver, and the like.

Second device 1304 may include, for example, an input/output 1332. Input/output 1332 is representative of one or more devices or features that may be configurable to accept or otherwise introduce human or machine inputs, or one or more devices or features that may be configurable to deliver or otherwise provide for human or machine outputs. By way of example but not limitation, input/output device 1332 may include an operatively configured display, speaker, keyboard, mouse, trackball, touch screen, data port, etc.

Methodologies described herein may be implemented by various approaches depending at least in part upon applications according to particular examples. For example, such methodologies may be implemented in hardware, firmware, software, or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform functions described herein, or combinations thereof.

“Instructions” as referred to herein relate to expressions which represent one or more logical operations. For example, instructions may be “machine-readable” by being interpretable by a machine for executing one or more operations on one or more objects. However, this is merely an example of instructions and claimed subject matter is not limited in this respect. In another example, instructions as referred to herein may relate to encoded commands which are executable by a processing circuit having a command set which includes encoded commands. An instruction may be encoded in the form of a machine language understood by a processing circuit. Again, these are merely examples of an instruction and claimed subject matter is not limited in this respect.

“Storage medium” as referred to herein relates to media capable of maintaining expressions which are perceivable or processable by one or more machines. For example, a storage medium may comprise one or more storage devices for storing machine-readable instructions or information. Storage devices may comprise any one of several media types including, for example, magnetic, optical or semiconductor storage media. Storage devices may also comprise any type of long term, short term, volatile or non-volatile memory devices. However, these are merely examples of a storage medium, and claimed subject matter is not limited in these respects.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

While there has been illustrated and described what are presently considered to be example features, it will be understood by those skilled in the art that various other modifications may be made, or equivalents may be substituted, without departing from claimed subject matter. Additionally, many modifications may be made to adapt a particular situation without departing from claimed subject matter. Therefore, it is intended that claimed subject matter not be limited to the particular examples disclosed, but that such claimed subject matter may also include all aspects falling within the scope of the appended claims, or equivalents thereof.

1. A method for differentiating among congestive packet loss, packet reordering, or random packet loss comprising:
managing multiple timers at least in part in response to transmitting a signal packet, wherein said timers are set to start or expire at different time instances; and
activating one or more signal transmission control functions after expiration of one or more of said timers, wherein said one or more signal transmission control functions comprise congestion control measures or loss recovery measures.

2. The method of claim 1, wherein the expiration periods of said timers are determined as functions of overall packet loss rate, congestive packet loss rate, or size of congestion window.

3. The method of claim 1, wherein said managing and said activating are compatible with a transmission control protocol (TCP).

4. A method for differentiating congestive packet loss, packet reordering, or random packet loss comprising:
starting a retransmission decision timer at least in part in response to injecting a signal packet into a network;
retransmitting the signal packet and starting a congestion control decision timer at least in part in response to an expiration of said retransmission decision timer, if an acknowledgment packet for the signal packet has not arrived; and
designating the signal packet to be lost at least in part in response to an expiration of the said congestion response decision timer, if an acknowledgment packet for the signal packet has not arrived.

5. The method of claim 4, wherein the expiration periods of said retransmission decision timers or said congestion response decision timers are determined as functions of overall packet loss rate, congestive packet loss rate, or size of congestion window.

6. The method of claim 4, wherein said starting, retransmitting, or designating are compatible with a transmission control protocol (TCP).

7. A method for differentiating congestive packet loss, packet reordering, or random packet loss comprising:
maintaining in storage a plurality of values of recent RTT samples;
starting a retransmission decision timer at least in part in response to injecting a signal packet into a network, wherein the expiration period of said retransmission decision timer is set to a maximum value among RTT samples in storage;
retransmitting the signal packet and starting a congestion control decision timer at least in part in response to the expiration of said retransmission decision timer if an acknowledgment packet for the signal packet has not arrived, wherein the expiration period of said congestion response decision timer is set to be a minimum value among RTT samples in storage; and
designating the signal packet to be lost after the expiration of said congestion response decision timer, if an acknowledgment packet for the signal packet has not arrived.

8. The method of claim 7, wherein the said maintenance of RTT samples comprises:
discarding RTT samples that have been in storage for the longest duration if the number of RTT samples exceeds the maximum RTT record length, wherein the maximum RTT record length comprises a selected positive integer signal value;
calculating a time delay upper bound by multiplying a minimum value among stored RTT samples by a scalar signal value, wherein said scalar signal value is selected to be greater than zero and less than one; and
performing RTT sampling and adding an RTT sample into RTT storage at least in part in response to arrival of an acknowledgment packet if an acknowledgment packet arrives before said retransmission decision timer expires or no later than said time delay upper bound after said retransmission decision timer expires.

9. The method of claim 7, wherein said starting, retransmitting, and designating are compatible with a transmission control protocol (TCP).

10. A method for differentiating among congestive packet loss, packet reordering, or random packet loss comprising:
maintaining in storage a plurality of values of recent RTT samples;
starting a retransmission decision timer at least in part in response to injecting a signal packet into a network, wherein an expiration period of said retransmission decision timer is set to a maximum value among RTT samples in storage;
retransmitting the signal packet and starting a congestion control decision timer at least in part in response to expiration of said retransmission decision timer if an acknowledgment packet for the signal packet has not arrived, wherein the expiration period of said congestion response decision timer is set to be a minimum value among RTT samples in storage; and
designating the signal packet to be lost after expiration of said congestion response decision timer, if an acknowledgment packet for the signal packet has not arrived;
starting a retransmission timer after transmitting a packet, a retransmission timer is not yet started, and resetting said retransmission timer if it is already started, wherein the expiration period of said retransmission timer is set to be the sum of the expiration period of said retransmission decision timer and twice the expiration period of said congestion decision timer;
designating a network to be congested and signal packets in transit to be lost upon the expiration of the said retransmission timer, if any retransmitted packet is not acknowledged within the expiration period of the retransmission decision timer, or the size of congestion window is less than one.

11. The method of claim 10, wherein said maintenance of RTT samples comprises:
discarding RTT samples that have been in storage for a longest duration if the number of RTT samples exceeds a maximum RTT record length, wherein said maximum RTT record length comprises a selected positive integer;
calculating a time delay upper bound by multiplying a minimum value among stored RTT samples by a scalar signal value, wherein said scalar signal value is selected to be greater than zero and less than one; and
performing RTT sampling and adding a RTT sample into RTT storage at least in part in response to arrival of an acknowledgment packet if the acknowledgment packet arrives before said retransmission decision timer expires or no later than said time delay upper bound after said retransmission decision timer expires.

12. The method of claim 10, comprising a congestion management process compatible with a transmission control protocol (TCP).

13. An apparatus, comprising:
means for managing multiple timers at least in part in response to transmitting a signal packet, wherein said timers are set to start or expire at different time instances; and
means for activating one or more signal transmission control functions after expiration of one or more of said timers, wherein said one or more signal transmission control functions comprise congestion control measures or loss recovery measures.

14. The apparatus of claim 13, wherein expiration periods of said timers are to be determined as functions of overall packet loss rate, congestive packet loss rate, or size of congestion window.

15. The apparatus of claim 13, wherein said means for managing and said means for activating operate in a manner compatible with a transmission control protocol (TCP).

16. The apparatus of claim 13, wherein the apparatus comprises one or more of a programmable logic device (PLD), a field programmable gate array (FPGA), or an application-specific integrated circuit (ASIC).

17. An article, comprising: a storage medium having stored thereon instructions executable by a computing platform to:
manage multiple timers at least in part in response to transmitting a signal packet, wherein said timers are set to start or expire at different time instances; and
activate one or more signal transmission control functions upon expiration of one or more of said timers, wherein said one or more signal transmission control functions comprise congestion control measures or loss recovery measures.

18. The article of claim 17, wherein expiration periods of the said timers are determined at least in part as functions of overall packet loss rate, congestive packet loss rate, or size of congestion window.

19. The article of claim 17, wherein the storage medium has stored thereon further instructions executable by a computing platform to manage said multiple timers and said activating said one or more data transmission control functions in a manner compatible with a transmission control protocol (TCP).
